(19) United States
(12) Patent Application Publication
(10) Pub. No.: US 2017/0030396 A1
(43) Pub. Date: Feb. 2, 2017

(54) Socket Extension for Threaded Insert

(71) Applicant: A. Stucki Co., Moon Township, PA (US)

(72) Inventors: Scott D. Miner, Pittsburgh, PA (US); Victoria K. Livingston, Bethel Park, PA (US)

(21) Appl. No.: 14/810,942

(22) Filed: Jul. 28, 2015

(51) Int. Cl. F16B 37/08

(52) U.S. Cl. CPC F16B 37/08

(57) ABSTRACT

A fastening device includes an insert and an extension bar, where the insert is configured to have a coupling engagement with a bolt so that when coupled together they form a fastener. The insert may include a bolt aperture and an extension aperture. An extension bar may be inserted within the extension aperture to assist with placing and holding the insert into position while the bolt is inserted into the bolt aperture. The bolt and insert may be used to generate a mating engagement between two ancillary structures and fasten them together. While connected to the insert, the extension may be used to assist with maneuvering, positioning, stabilizing and angling the insert to facilitate alignment between the bolt and the bolt aperture. The extension bar may be removed from the extension aperture after the mating engagement is formed.

### FIELD OF THE INVENTION

The present invention is directed toward a tool used to generate a fastening engagement between two structures and, more particularly, toward a fastening insert used where the space provided for the mating engagement is constrained or the configuration of the structures generates a compromising work setting.

### BACKGROUND OF THE INVENTION

Many structures and equipment components are modular and require temporary and/or permanent fastening. A common form of fastening is a nut and bolt. Unfortunately, design parameters and other constraints sometimes dictate that the mating engagement between these components occurs at an inconvenient location for a user attempting to fasten the components together. For example, some mating engagements are between brackets positioned well within an engine compartment, the parts of which may be hot and spatially constricting. Other mating engagements may be located on equipment that requires users to use poor ergonomics and compromising postures that are unsafe in order to complete the fastening. Still further, other mating engagements require the use of large, heavy fasteners that make it even more difficult for a user.

Existing fasteners consist of a nut that engages a bolt (threadingly or otherwise) to complete the fastening. Typically, the bolt is inserted through apertures of the structure and engages the nut, which when advanced towards each other, generates the mating engagement. Wrenches or sockets are used to hold and/or manipulate the nut and/or bolt to effectuate the advancement toward each other. Typically, a second wrench or socket is used in an attempt to hold the nut while the first wrench is used to manipulate the bolt, or vice versa. However, wrenches and sockets are designed for leverage and torque, and therefore are not well suited to hold and/or manipulate the nut when the nut is positioned in the constrained and/or compromising position and/or location as described above. For example, it may simply be impossible to maneuver a wrench into a small space in order to engage the nut and/or bolt.

Other tools exist, such as, for example, sockets, that attempt to hold the nut in a stationary position while the bolt is advanced, but these are also inadequate for several reasons. One of the reasons for their inadequacy is that these tools typically require being placed over or around the nut. This proves to be difficult if the nut is in a compromising position or location, and nearly impossible if the nut is large and heavy. Furthermore, the constrained space may not provide enough headroom to place the tool on or around the nut. In addition, such tools are not well suited to maneuver and position the nut without slipping from the nut or inhibiting rotational motion of the nut relative to the tool.

The present invention is directed toward overcoming one or more of the above-identified problems.

### SUMMARY OF THE INVENTION

The inventive device includes an insert used as part of a fastener. The insert may be configured to have a coupling engagement with a bolt so that when coupled together they form a fastener. A bolt aperture and an extension aperture are formed into the insert. An extension bar (which assists a user with placement and positioning of the insert during use) may be inserted within the extension aperture to assist with positioning and stabilizing the insert while the bolt is inserted into the bolt aperture. In some embodiments, the insert may be placed in a constrained position with the assistance of the extension bar and used to generate a mating engagement between two ancillary structures so as to fasten the two structures together. After the mating engagement is formed, the extender bar may be removed from the extension aperture.

As described above, the extension bar may enable placement of the insert in constrained areas or compromising locations of, for example, two ancillary structures. This may include introduction of the insert within a bracket, placing the insert against a platform located within large machinery, placing the insert against a hot manifold within an engine compartment, placing the insert in a cavity formed in the structure, etc. For example, in one exemplary embodiment, the insert may be used as a nut to couple an air hose hanger to a railcar coupler by introducing the insert within the railcar coupler and holding it in place while a bolt is introduced from outside the coupler through the air hose hanger and is advanced into the bolt aperture. While connected to the insert, the extender bar may be used to assist with maneuvering, positioning, stabilizing and angling the insert to facilitate alignment between the bolt and the bolt aperture. This may be especially beneficial if the insert is large or heavy.

While these potential advantages are made possible by technical solutions offered herein, they are not required to be achieved. The presently disclosed device can be implemented to achieve technical advantages, whether or not these potential advantages, individually or in combination, are sought or achieved.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present invention will be more apparent from the following more particular description thereof, presented in conjunction with the following drawings, in which:

FIG. 1 shows a perspective view of the inventive insert;

FIG. 2 shows a side view of the inventive insert;

FIG. 3 shows another perspective view of the inventive insert with a threaded bolt aperture;

FIG. 4 shows the inventive insert with the extension bar inserted into the extension aperture of the insert;

FIG. 5 shows the inventive insert with the extender bar in juxtaposition with the insert; and,

FIG. 6 shows an environmental view of the inventive insert being used to secure an air hose hanger to a railcar coupler.

### DETAILED DESCRIPTION OF THE INVENTION

The following description is of an embodiment presently contemplated for carrying out the present invention. This description is not to be taken in a limiting sense, but is made merely for the purpose of describing the general principles and features of the present invention. The scope of the present invention should be determined with reference to the claims, which are to be given the full breadth thereof.

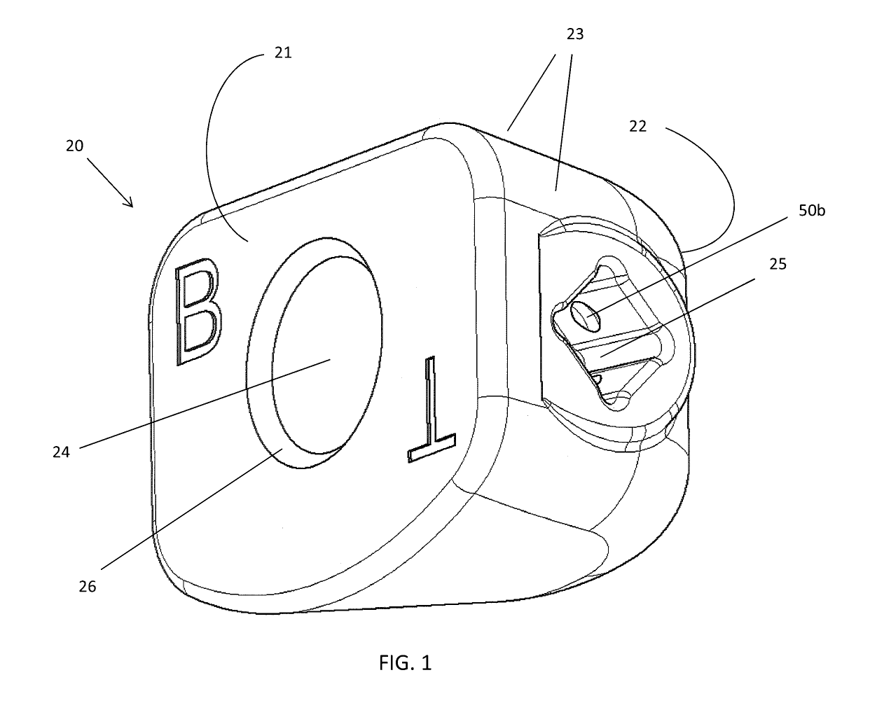

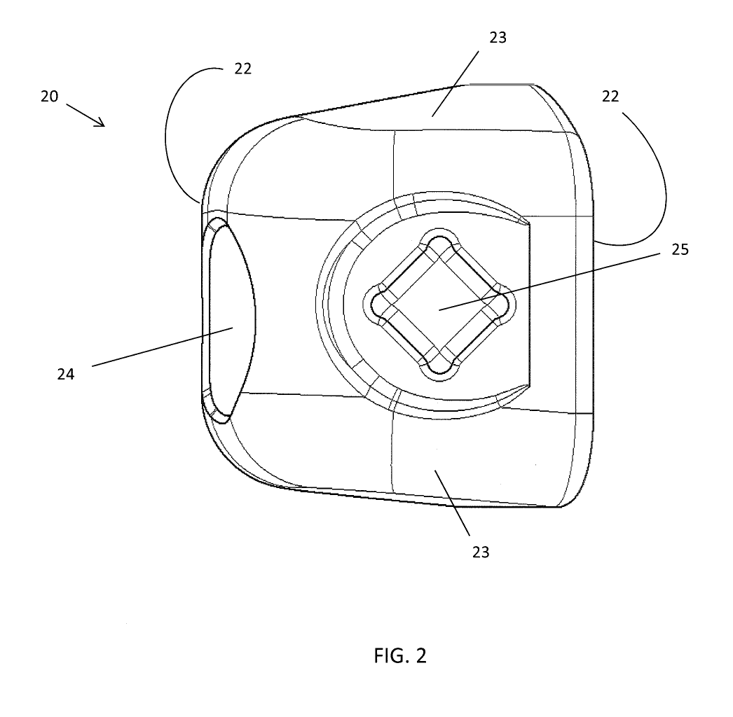

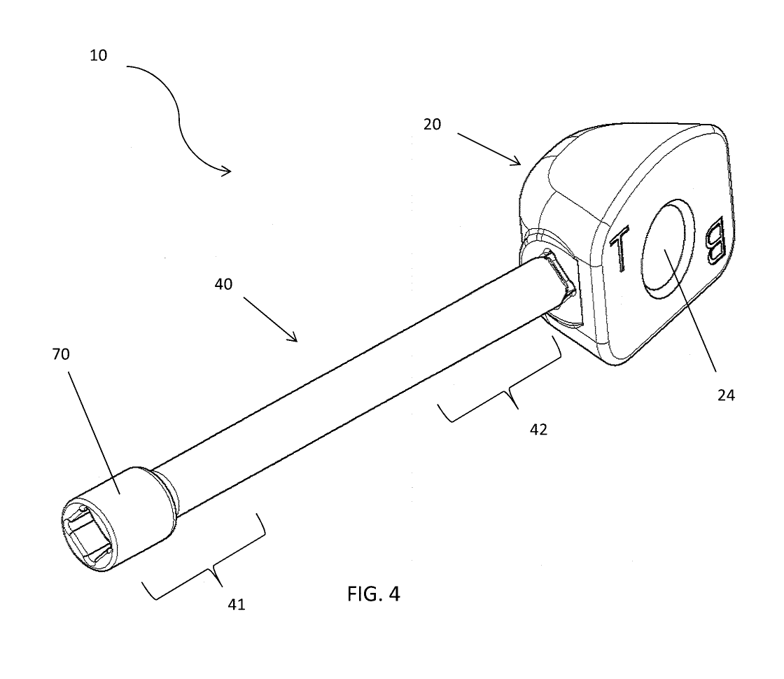

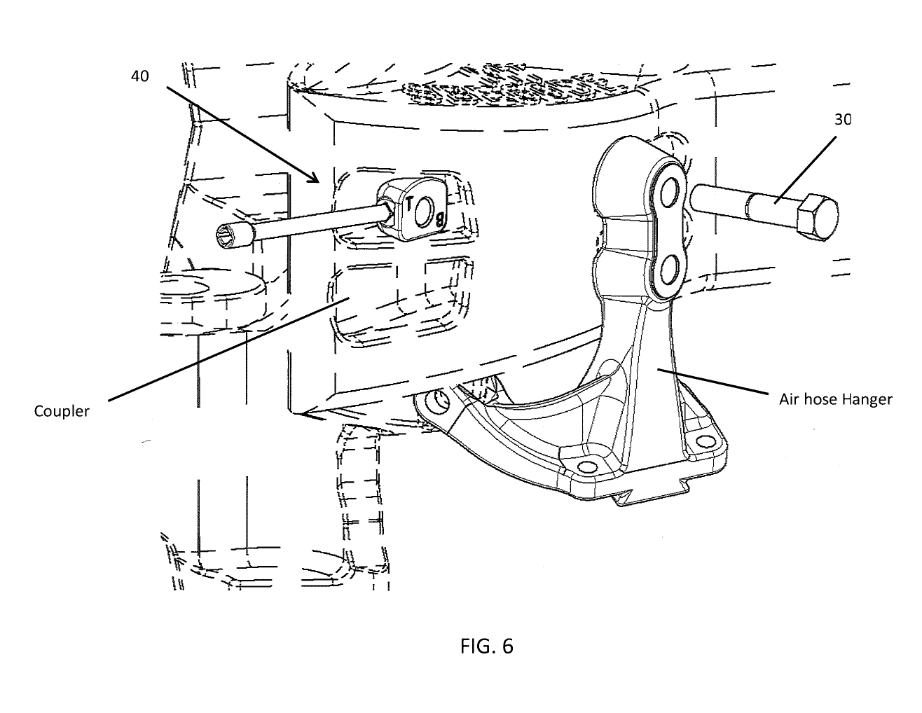

Referring now to FIGS. 1-3, the insert 20 may comprise metal, ceramic, rubber, plastic, or other suitable material capable of supporting the loads, stresses, and strains associated with the particular coupling application for which it will be used. The insert 20 may include a disk-like member having a front face 21, a rear face 22, and a circumferential side surface 23 between the front 21 and rear 22 faces. A bolt aperture 24 may be formed within the front face 21 and/or the rear face 22 and configured to receive a bolt 30 (see FIG. 6) or other type of fastening member. The aperture 24 may extend all the way through the insert 20, or only partially there through. An extension aperture 25 is formed within the circumferential side surface 23 and may be configured to receive an extension bar 40 (see FIG. 4) or any other appropriate tool. In addition, while not shown, the insert 20 may be provided with a buffer plate or bumper member disposed on a surface thereof (side, front or rear) for shock absorbance, abrasion resistance, etc. This bumper may be configured as a seal ring or gasket if the insert were to be used as a sealing component of a piece of equipment.

The faces 21, 22 may be flat, convex, conical, or any other shape. Similarly, the side 23 may be circular, polygonal, or any other shape. The shape of the faces 21, 22 and side 23 may be configured to accommodate the space within which the insert 20 is to be used. For instance, if the insert 20 is for coupling an air hose hanger to a railcar coupler, the first face 21 may be flat, the rear face 22 may be conical, and the side 23 may form a convex polygonal shape, as shown in FIG. 6. Such a configuration may accommodate insertion into the railcar coupler so as to complement the coupler cavity associated with the lightener holes and generate a secure fit.

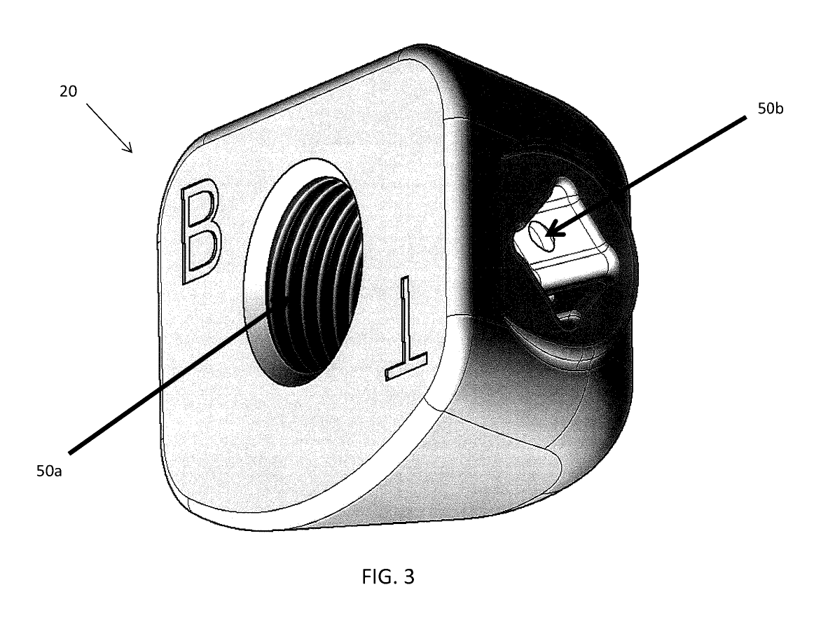

In some embodiments, the bolt aperture 24 protrudes through the disk-like member, extending from the front face 21 to the rear face 22, and the extension aperture 25 is configured as a dead hole (meaning does not extend all the way through). This configuration may enable insertion of the extension bar 40 within the extension aperture 25 without interference of traverse motion of the bolt 30 through the bolt aperture 24 because the extender bar 40 abuts against an inner wall of the dead hole without intruding into the bolt aperture 24. However, other configurations may be utilized. For instance, the extension aperture 25 may not be a dead hole, but rather protrude through the disk-like member, extending from a point on the side 23 to a subtending point of the side 23 but without crossing into the line of path formed by the bolt aperture 24. In another embodiment, the extension aperture 25 may cross into the path of the bolt aperture 24 to enable the extender bar 40 to intrude into the bolt aperture 24. As will be explained more later, the extension aperture 25 may be provided with an insert retention means 50b, which not only temporarily secures the extender bar 40 within the extension aperture 25, but also may serve as a mechanical stop to prevent the extender bar 40 from intruding into the bolt aperture 24. Other mechanical stops may be utilized, which may include a rim or tab disposed at or near the opening of the extension aperture 25, or even a tapered shape to the extension aperture 25. Furthermore, the bolt aperture 24 may be configured as a dead hole (meaning not extending all the way through) having the same or similar features. The bolt aperture 24 may be threaded 50a (see FIG. 3) or not threaded.

Other configurations may include the bolt aperture 24 on the side 23. Further configurations may include the extension aperture 25 on any one of the front 21 and rear faces 22. In addition, the insert 20 may be provided with a plurality of bolt apertures 24 and/or a plurality of extension apertures 25. At least one of the apertures 24, 25 may be conjoined with another of the same type of aperture 24, 25. For instance, a first extension aperture 25 may extend from the front face 21 to conjoin with a second extension aperture 25 extending from the side 23. Similar configurations may exist for the bolt aperture 24.

The apertures 24, 25 may exhibit a variety of shapes. As shown in FIGS. 1-3, the bolt aperture 24 may be circular, whereas the extension aperture 25 may be polygonal. The shapes of the apertures 24, 25 may be chosen to accommodate and/or complement the shapes of the bolt 30 and extension bar 40, or other fasteners and tools being inserted therein; therefore, the shapes are not limited to what is illustrated in the Figures.

The polygonal shape of the extension aperture 25 may provide added utility by inhibiting free rotational movement of the insert 20 relative to the extender bar 40. In an exemplary use of the device 10 (see FIG. 4), the extension bar 40 is inserted into the extension aperture 25 and the insert 20 is introduced into a location for engagement with the bolt 30 (such as, for example, into the cavity of a railcar coupler), and held in place by the extension bar 40 (see FIG. 6). The bolt 30, which may be threaded, is inserted into the bolt aperture 25, which may also be threaded. A user would hold the insert 20 stationary via the extender bar 40 while the bolt 30 is advanced, via the threading or other engagement of the bolt 20 and bolt aperture 24, toward the insert 20. In this example, as the extension bar 40 is inserted into the extension insert 25, the extender bar 40 enables a user to prevent rotational motion of the insert 20 as the bolt 30 is advanced. In addition to a polygonal socket type connection, other shapes and configurations can be used to inhibit free rotational motion of the insert 20, such as a splined/keyed engagement or a threaded engagement between the extension bar 40 and the extension aperture 25.

In addition, any of the apertures 24, 25 may exhibit a flare 26 (see FIG. 1), wherein the outer portion of the aperture 24, 25 is wider than that of the inner portion. This may enable easier guidance of the bolt 30 or extension bar 40 into the respective aperture 24, 25. Some embodiments may include a flange or collar disposed around the aperture 24, 25, which again may be flared for the same purpose.

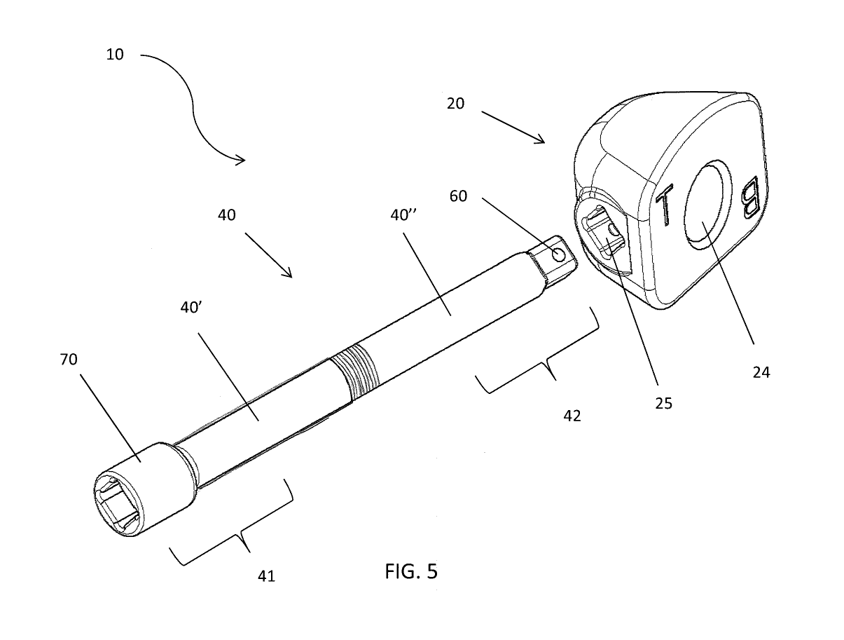

An extension retention means 50b (see FIGS. 1 and 3) within the extension aperture 25 may be provided to temporarily retain the extension bar 40 therein. The extension retention means 50b may be a threading engagement, a pin and detent engagement (similar to a socket engagement), or the like. For example, the extension aperture 25 may have a detent 50b disposed on an inner surface thereof that mechanically engages with a spring-loaded pin 60 (see FIG. 5) of the extension bar 40 (similar to a socket connection). Alternatively, the extension bar 40 may be provided with the detent and the extension aperture 25 with the spring-loaded pin. Furthermore, the bolt 30/bolt aperture 24 may also operate via the pin/detent engagement, and/or the extension bar 40/extension aperture 25 may operate via the threaded engagement. Other coupling engagements may include, but are not limited to, magnetic couplers, bayonet-style fasteners, a cam, interference fit, etc. In a preferred form, the extension bar 40 is removably connected to the insert 20 to allow the insert to be positioned at a desired location and attached to the bolt 30. Then the extension bar 40 is removed.

The extension retention means 50b may further enable a user to maneuver, position, stabilize and angle the insert 20 to facilitate alignment between the bolt 30 and the bolt aperture 24 by securely holding the extension bar 40 to the insert 20. As shown in FIG. 6, when the insert 20 is introduced into a very constraining space (e.g., a cavity in a railcar coupler in communication with the lightener holes) and used to fasten an air hose hanger thereto, a compromising work setting for a user may be generated. Not only does the device 10 enable a user to easily place and hold the insert 20 within the railcar coupler, but it may be beneficial to use the extension bar 40 as leverage to manipulate the insert 20 for alignment. As seen in FIG. 6, the railcar coupler may have a channeled configuration in which the insert 20 may be used to provide the complementary fastener to a bolt 30. The air hose hanger may be coupled to the railcar coupler by insertion of the bolt 30 through the hanger and into the insert 20. The nature of the channel renders it difficult to place, hold, and manipulate the insert 20, but for the extension bar 40.

Referring now to FIGS. 4-5, the extension bar 40 may include an elongated member having a first end 41 and a second end 42, and it may comprise the same or similar materials as that of the insert 20. While the extension bar 40 is shown as being straight, it may exhibit other shapes, such as curvilinear, angled, etc. The various shapes may provide added leverage or enable insertion into contorted work spaces.

At least one of the first end 41 and the second end 42 may have the cooperating extension retention means 60 to temporarily retain the extension bar 40 within the extension aperture 25. The extension retention means 60 may be the same type or similar type of mechanisms as previously described.

In some embodiments, only the second end(s) 42 of the extension bar 40 exhibits a complementary shape as that of the extension aperture 25. This is illustrated in FIG. 5, wherein the extension bar body is cylindrical, but the second end 42 is a generally square shape. The benefits of the square shape, and other shapes (e.g., polygonal, etc.), of the second end 42, along with the square shape of the extension aperture 25, were described above. In particular, the square shape may be exploited to inhibit free rotational movement of the insert 20 relative to the extension bar 40 when the extension bar 40 is engaged with the insert 20. Different shapes and configurations of the extension bar body may be used to increase dexterousness or even accommodate less expensive manufacturing methods. For example, a cylindrical shape may be better for grasping the extension bar 40. A hexagonal shape may assist with gripping and prevent slippage when handing the extension bar 40. In some embodiments, the extension bar 40 is hollow to lighten its weight. This may require a polygonal shape, or other shapes, applied to the extension bar 40 so as to add structural rigidity and strength to the hollow structure.

In some embodiments, a distal end of the extension bar 40 may be configured as a socket 70 to receive at least one of another extension bar 40 and/or another tool. Thus, the first end 41 may be configured as the socket 70 and the second end 42 may exhibit the complementary shape of the insert aperture 25. The extension retention means 60 of the second end 42 may be used to temporarily retain the extension bar 40 in the extension aperture 25 of the insert 20, or a socket 70 of a second extender bar (not shown). Similarly, a socket retention means (not shown), which may be the same type or similar type of mechanisms as those of the retention means 50a, 50b, may be used to temporarily retain first and second extension bars together.

In addition, the second end 42 of the extender bar 40 may be configured to removably receive an ancillary mechanical socket, thereby enabling interchangeability of socket ends. In this embodiment, the extension retention means 60 would enable the temporary securement of the various mechanical sockets.

In some embodiments, the extension bar 40 includes a handle (not shown) to provide added dexterity when manipulating the device 10. The handle may include a textured surface or a rubber and/or polymer member disposed on a surface thereof. Moreover, the extension bar 40 may be expandable in length. The may be achieved via a telescoping engagement of a plurality of extender body portions 40′, 40″ (see FIG. 5). These extension bar portions 40′, 40″ may be threadingly engaged for example, as shown in FIG. 5. Portion 40′ may be hollow and have a threaded inner surface, and portion 40″ may have a complementary threaded outer surface. Thus, extension bar portions 40′, 40″ may be configured to engage each other so as to enable selective expansion and contraction of the length of the extension bar 40.

Other embodiments may include at least one ball joint connecting portions of an extension bar 40 together to enable angled articulation of two or more portions.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the end points.

I/We claim:

1. A fastening insert device comprising:
a disk-like member having a front face, a rear face, and a circumferential side surface between the front and rear faces, and a bolt aperture configured to receive a bolt formed in at least one of the front face and the rear face, the disk-like member further including an extension aperture formed in the circumferential side surface, wherein the extension aperture is configured to removably receive an ancillary tool.

2. The fastening insert device recited in claim 1, wherein the bolt aperture protrudes through the disk-like member, extending from the front face to the rear face.

3. The fastening insert device recited in claim 1, wherein the extension aperture has an extension retention device to removably retain the ancillary tool in the extension aperture.

4. The fastening insert device recited in claim 3, wherein the extension retention device is a threading engagement.

5. The fastening insert device recited in claim 3, wherein the extension retention device is a pin and detent engagement.

6. The fastening insert device recited in claim 1, wherein the extension aperture has a polygonal shape corresponding to a shape of an end of the ancillary tool.

7. The fastening insert device recited in claim 1, wherein the extension aperture is configured as a dead hole in the circumferential side surface.

8. A fastening insert device comprising:
a disk-like member having a front face, a rear face, and a circumferential side surface, and a bolt aperture configured to receive a bolt formed in at least one of the front face and the rear face, the disk-like member further including an extension aperture formed in the circumferential side surface; and
an extension bar comprising an elongated member having a first end and a second end,
wherein the extension aperture is configured to removably receive at least one of the first end and the second end of the extension bar.

9. A fastening insert device recited in claim 8, wherein the bolt aperture protrudes through the disk-like member, extending from the front face to the rear face.

10. The fastening insert device recited in claim 7, wherein the extension aperture has an extension retention device to removably retain the extension bar in the extension aperture.

11. The fastening insert device recited in claim 10, wherein the extension retention device is a threading engagement.

12. The fastening insert device recited in claim 10, wherein the extension retention device is a pin and detent engagement.

13. The fastening insert device recited in claim 8, wherein the extension aperture has a polygonal shape corresponding to a shape of an end of the extension bar.

14. The fastening insert device recited in claim 8, wherein at least one of the first end and the second end of the extension bar is configured as a socket to receive at least one of another extension bar.

15. The fastening insert device recited in claim 14, wherein an end opposite the socket end has an extension retention device to removably retain the extension bar within the extension aperture.

16. The fastening insert device recited in claim 8, wherein at least one of the first end and the second end of the extension bar has an extension retention device to removably retain the extension bar within the extension aperture.

17. The fastening insert device recited in claim 8, wherein the extension bar comprises a plurality of extension bar portions configured to telescopingly engage each other so as to enable selective expansion and contraction of a length of the extension bar.

18. The fastening insert device recited in claim 8, wherein the extension aperture is configured as a dead hole.
